(19) United States
(12) Patent Application Publication
(10) Pub. No.: US 2006/0233949 A1
(43) Pub. Date: Oct. 19, 2006

(54) Method for forming a pattern on a substrate and device formed by the same

(76) Inventor: Shih Chung Wu, Taipei (TW)

Correspondence Address: Shih Chung Wu, 235 Chung-Ho, Box 8-24, Taipei, TW

(21) Appl. No.: 11/107,699

(22) Filed: Apr. 18, 2005

(51) Int. Cl. B41M 3/12

(52) U.S. Cl. 427/147; 427/146

(57) ABSTRACT

A method for forming a pattern on a substrate comprises the steps of; locating a substrate; adhering a plurality of plate layers upon the substrate one by one by gluing; the plurality of plate layers having different colors or textures; transferring the substrate with the plurality of plate layers to a cutting area; and punching upon the plate layers by a cutting unit so as to form a plurality of cutting wires as outlines of at least one small areas. further A pattern forming device comprises a substrate; and a plurality of plate layers having different colors or textures; the plate layers being adhering upon the substrate one by one; the plurality of plate layers having cutting wires formed thereon; the cutting wires being formed with at least one small areas so that the small area can be torn away.

### FIELD OF THE INVENTION

The present invention relates to method for forming a pattern on a substrate, wherein a pattern can be formed by tearing a small area enclosed by at least one cutting wire so as to form a desired pattern on a substrate. Furthermore, the present invention relates to a pattern forming device which can be formed by above method.

### BACKGROUND OF THE INVENTION

In the prior art a drawing book, such as those used for children, each page of the drawing book has different pattern which is formed a plurality of lines. Thereby the user can draw different color into the patterns enclosed by the lines. However the prior art has a defect, namely, if a undesired color is drawn into an area, it is uneasy to redraw the area with another color.

In current drawing program in a computer, the user can fill a desired color to a pattern displayed at the computer display. If the color is not desired, the user can change a desired one by using a simple operation, but this is not suitable in a computer display. In current practical drawing book, the user cannot redraw the color conveniently and easily.

### SUMMARY OF THE INVENTION

Accordingly, the object of the present invention is to provide a method for forming a pattern on a substrate, wherein a pattern can be formed by tearing a small area enclosed by at least one cutting wire so as to form a desired pattern on a substrate.

To achieve above object, the present invention provide a method for forming a pattern on a substrate comprising the steps of; locating a substrate; adhering a plurality of plate layers upon the substrate one by one by gluing; the plurality of plate layers having different colors or textures; transferring the substrate with the plurality of plate layers to a cutting area; and punching upon the plate layers by a cutting unit so as to form a plurality of cutting wires as outlines of at least one small areas.

Furthermore, the present invention provide a pattern forming device which comprises a substrate;a plurality of plate layers having different colors or textures; the plate layers being adhering upon the substrate one by one; the plurality of plate layers having cutting wires formed thereon; the cutting wires being formed with at least one small areas so that the small area can be torn away to display the color or patter of one of the plate layers below the torn small area so as to form a pattern.

The various objects and advantages of the present invention will be more readily understood from the following detailed description when read in conjunction with the appended drawing.

### BRIEF DESCRIPTION OF THE DRAWINGS

FIGS. 1 to 4 shows the manufacturing process of the present invention.

FIG. 5 is a flow schematic view about the structure of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

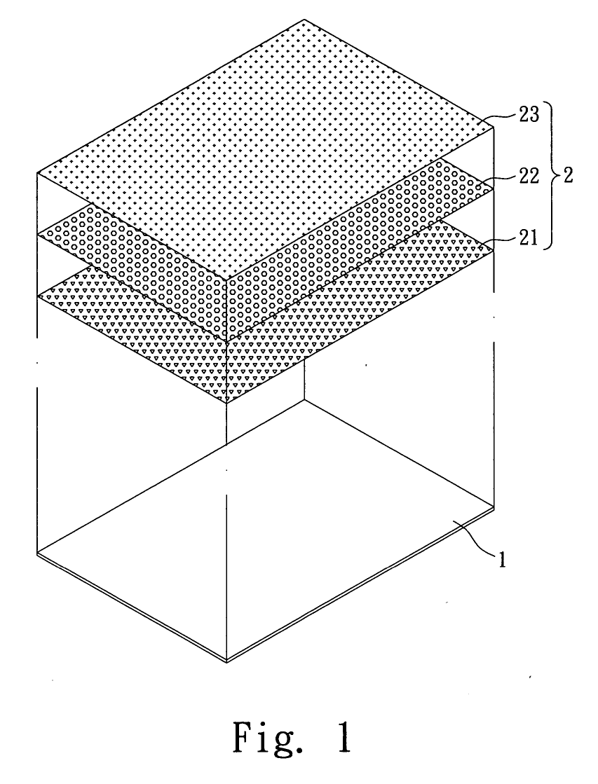

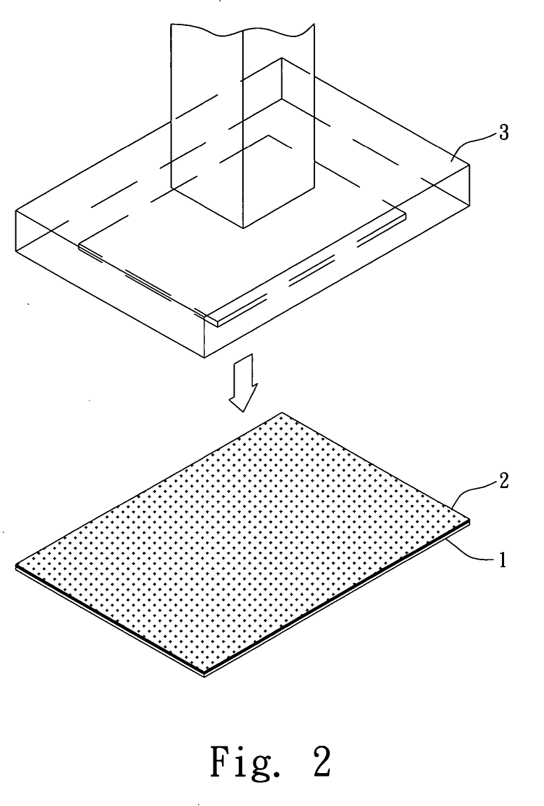

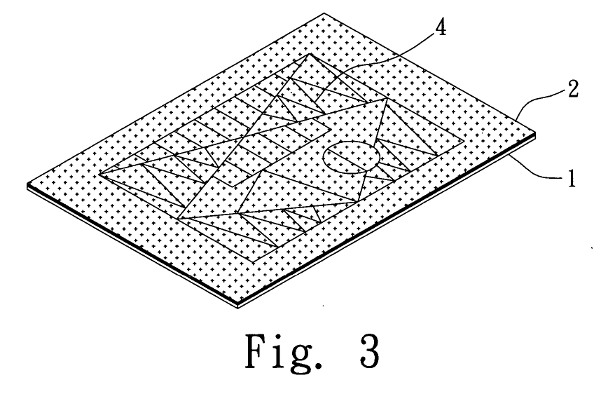

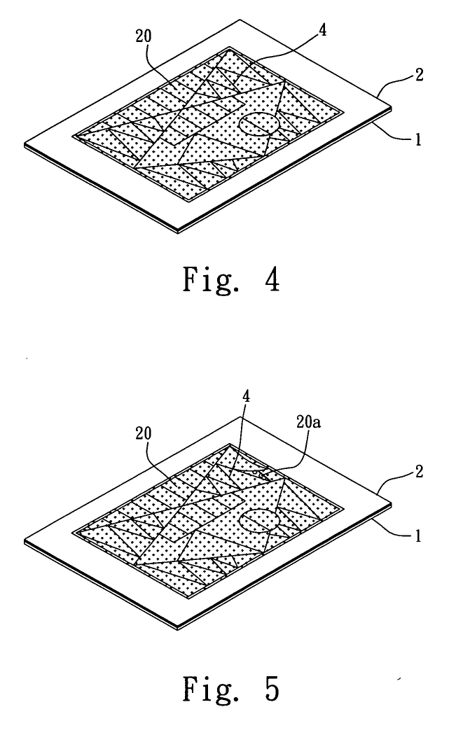

Referring to FIGS. 1 to 4, the flow diagram of the present invention is illustrated. The method of the present invention will be described herein.

The present invention has the following steps.

A substrate 1 is made of papers, adhesive tapes, acrylic fiber, woods, plastics,

A plurality of plate layers 2 are selected. The plurality of plate layers 2 have different colors or textures. A layer of glues are coated on the plate layers by using a roller as so as to form a semi-product. The plate layers 2 includes a first plate layer 21, a second plate layer 22 and a third plate layer 23, etc. One surface of the first plate layer 21 coated with glue is adhered to a surface of the substrate 1. One surface of the second plate layer 22 coated with glue is adhered to another surface of the first plate layer 21 not glued. One surface of the third plate layer 23 coated with glue is adhered to another surface of the second plate layer 22 not glued. The process is performed one by one until all the plate layers are adhered to the lower layers. It is preferred the adhering operation is performed by a roller of a printing machine. Furthermore, the plate layers are selected from color papers or adhesive tapes, etc.

After completing above process, the semi-product is transferred to a cutting area. A pattern cutting unit 3 serves to punch upon the plate layers so as to form a plurality of cutting wires 4 as outlines of at least one small area 20.

Referring to FIG. 5, the structural schematic view of the present invention is illustrated. It is illustrated that the structure of the present invention includes a substrate 1, a plurality of plate layers of different colors or patterns are sequentially adhered upon the substrate 1. The plate layers 2 are formed with a plurality of cutting wires 4 so as to form a pattern.

In operation, the small areas 20 enclosed by the cutting wires 4 are torn down from the plate layers 2. For example if the small area 20a is torn, and then the color of the plate layer below the small area 20 is shown. Thereby to tear different plate layers, a pattern of different color is formed.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for forming a pattern on a substrate comprising the steps of;
locating a substrate;
adhering a plurality of plate layers upon the substrate one by one by gluing; the plurality of plate layers having different colors or textures;
transferring the substrate with the plurality of plate layers to a cutting area; and
punching upon the plate layers by a cutting unit so as to form a plurality of cutting wires as outlines of at least one small areas.

2. The stainless self-tapping screw as claimed in claim 1, wherein a material of the substrate is selected from one of papers, adhesive tapes, acrylic fiber, woods, amd plastics.

3. The stainless self-tapping screw as claimed in claim 1, wherein the plate layers are selected from one of colored papers and adhesive tapes.

4. The stainless self-tapping screw as claimed in claim 1, wherein the plate layer is glued by roller or by directly adhesion.

5. The stainless self-tapping screw as claimed in claim 1, wherein a glue not adhering to human skin is used in the gluing process.

6. A pattern forming device comprising:
a substrate;
a plurality of plate layers having different colors or textures; the plate layers being adhering upon the substrate one by one; the plurality of plate layers having cutting wires formed thereon; the cutting wires being formed with at least one small areas so that the small area can be torn away to display the color or patter of one of the plate layers below the torn small area so as to form a pattern.
